(19) United States
(12) Patent Application Publication
(10) Pub. No.: US 2018/0303048 A1
(43) Pub. Date: Oct. 25, 2018

(54) IRRIGATION SYSTEM

(71) Applicant: Bookleaf Pty Ltd, Osborne Park (AU)

(72) Inventors: Walter John EDWARDS, Floreat (AU); Michael Barrington WOOD, Mount Lawley (AU)

(21) Appl. No.: 15/769,202

(22) PCT Filed: Oct. 20, 2016
(86) PCT No.: PCT/AU2016/050985

§ 371 Date: Apr. 18, 2018

(30) Foreign Application Priority Data
Oct. 20, 2015 (AU) 2015904293

(51) Int. Cl. A01G 25/16; F16K 31/02; G05B 19/042

(52) U.S. Cl. CPC A01G 25/16; G05B 2219/2625; G05B 19/042; F16K 31/02

(57) ABSTRACT

An irrigation controller and valves incorporating an irrigation controller, which have user allocatable identification numbers, is disclosed. The controller and valves are programmed when to operate according to their identification number, and the program is uploaded and stored in each controller or valve as the case may be, together with clock data. The controller and valves then perform time keeping and operate according to the stored program. The controller and valves are intended to be battery operated, obviating the need to install wiring to connect the valves back to a central controller. This allows simplified installation and programming, and provides improved flexibility in programming of irrigation.

### TECHNICAL FIELD

This invention relates to the field of irrigation for the watering of lawns and gardens and in particular relates to an irrigation system for controlling such irrigation.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

Irrigation controller installations typically include parallel wiring of electrically operated valves and pump controllers, with a single wire being provided to connect to each electrically operated valve and master electrically operated valve or pump controller (typically a relay, either mechanical or solid state), and a return wire. Thus with such an arrangement in an eight zone/station system with a master valve or pump would require a minimum of ten wires to connect between all of the valves/pump control and the irrigation controller. Typically the irrigation controller includes a microprocessor and the runtimes for each station are programmed by the user. The stations are stacked so that they operate sequentially, one by one. Most controllers have the ability to allocate stations to particular programs, so that stations can be grouped and run at times suited to the particular vegetation being watered.

There has been a move in recent times in such installations to providing, a single pair of wires connecting in parallel all electrically operated valves and pump control, with the single pair of wires supplying the power to operate the connected devices, and the connected devices being addressed for on/off control by a serially encoded binary data string superimposed on the two wires. Each connected device has a specific address and responds to specific serially encoded binary data string containing that address information in order to allow the irrigation controller to control the connected device. These two wire systems function in the same way as the parallel wired systems, with the primary advantage of the two wire systems being a saving in the amount of wiring required to connect the electrically operated valves.

In addition to these systems, individual tap timers have also become popular in recent times. These are more portable in the sense that the user connects them to an outdoor tap/faucet which is left turned on, and watering takes place according to a program that the user enters into the tap timer using buttons and dials on the tap timer.

Where more than one tap timer is used in an installation, these are operated independently of each other, with the user having to take care that their programmed watering times do not overlap with each other or with the programmed times for the stations of an irrigation controller installation as described above, where that irrigation controller installation controls watering off mains/scheme water, or the same source of water that the tap timers use. The reason that overlapping times can be a problem is that there is often insufficient water pressure available to operate more than one station at a time.

Throughout the specification unless the context requires otherwise, the word “comprise” or variations such as “comprises” or “comprising”, will be understood to imply the inclusion of a stated integer or group of integers but not the exclusion of any other integer or group of integers.

### SUMMARY OF INVENTION

It is an object of the invention to provide an irrigation system that provides greater versatility for consumers, or at least provides an alternative to known systems.

In accordance with a first aspect of the invention, there is provided a flow control valve controller for an irrigation system, said flow control valve controller having at least one output to connect to an electrically operable valve operable between an off condition in which water under pressure would be prevented from flowing and an on condition in which water under pressure would be able to flow, operation of each said output being controlled by a processor interfaced with each said output by a switching circuit, said processor receiving address data being a user allocated identification number corresponding to a watering zone/station number allocated by the user to each said output, to set the watering zone/station number for each said output, and receiving by download and storing relative time data relating to the time of day, and receiving by download and storing operation timing data relating to said user allocated identification number allocated to said each said output, where said flow control valve controller continually updates stored relative time data based on internal clock data in order to track the time of day, and where said processor operates each said output in accordance with the stored operation timing data relating to each said user allocated identification number as allocated by the user to each said output. The advantage of this arrangement is the ability for the user to allocate the identification number to each output, allowing flexibility in adjusting watering sequences in an irrigation system built with the flow control valve controllers. The identification number is determined by the user and allocated by the user to be associated with the output concerned.

Preferably said processor receives and stores said address data.

Preferably, the operation timing data is pre-programmed in an external control unit, and uploaded from the external control unit to said flow control valve controller.

With this arrangement, an irrigation system may be built using a single flow control valve controller with outputs connected to a number of electrically operable valves. Each output has a user allocated identification number, and the electrically operable valve will operate at the time intended for the particular identification number allocated to the output. In addition, the operation timing data, which comprises an irrigation system watering program, may be pre-compiled by a user in the external control unit, before being sent to the flow control valve controller.

By way of explanation the identification number is a station number or zone number which may be an integer from 1 to 8, for example.

The external control unit can take the appearance of a traditional irrigation controller which is remotely located from said flow control valve controller, or as will be understood can be provided as an App for an iPhone or other Android device, or the like.

Preferably said processor receives and stores operation timing data relating to a plurality of different said identification numbers allocated to a plurality of said outputs/electrically operable valves, where said processor operates said output/electrically operable valve in accordance with the stored operation timing data relating to said identification number allocated to said output/electrically operable valve.

It will be appreciated that if two outputs have the same user allocated identification number, they will operate at the same time, in accordance with the stored operation timing data relating to the identification number allocated to the output.

Preferably said processor receives and stores operation timing data relating to one or more of a plurality of start times and run times or stop times, and days on which said start times may be allowed or over-ridden.

Preferably said processor is configured to add one minute between the programmed run time(s) or stop time(s), so that watering will not overlap at the change over between successive valves, in order to prevent a situation where there is reduced flow which could cause watering problems due to insufficient pressure.

Preferably said processor receives or updates said operation timing data as a compiled serial data stream.

Also preferably, said processor also receives or updates relative time data as a part of said compiled serial data stream.

Preferably each said user allocated identification number is received from a user operable selector switch. The user operable switch may be housed with the electronics of the flow control valve controller. Normally there would be one such user operable switch associated with each output.

Preferably each said user operable selector switch selects a number from 1 upward, corresponding to the watering zone/station number.

Preferably said user operable selector switch includes an off/manual override position, in which the associated said output is suspended from operating in accordance with the stored operation timing data, and may be operated manually. Manual operation may commence by the user selecting a manual override position, or by a separate user operable switch.

In one preferred form, the flow control valve controller incorporates a transceiver, through which said serial data stream is received. The transceiver need only be short range, and infrared may prove suitable, however, most preferably the transceiver is a radio transceiver. This may use Bluetooth, WiFi, or any other suitable standard.

Preferably said transceiver is arranged to be activated on operation of a user operable control located on the flow control valve controller for a predetermined period of time, whereafter in the absence of continuing data transmission or reception, said transceiver is deactivated. The user operable control may be the separate user operable switch identified above, or another user operable switch. If it is the separate user operable switch identified above, the flow control valve controller or flow control valve unit may be configured to not actuate the transceiver nor be reprogrammed in accordance with the data contained in the serial data stream, unless the user operable selector switch has selected a number from 1 upward, corresponding to the watering zone/station number.

With Bluetooth implementation, the flow control valve controller will be capable of being paired with the external control unit. The Bluetooth implementation will entail a Bluetooth identification number (MAC address) associated with each flow control valve controller, where the Bluetooth identification number (MAC address) associated with each flow control valve controller is stored in the external control unit, so that updates to the watering program that are made in the external control unit may be readily uploaded into each flow control valve controller. Where the identification number is implemented in software form, the identification number(s) allocated to any electrically operated valve to be associated with the flow control valve controller, is also stored in association with the Bluetooth identification number (MAC address) associated with the flow control valve controller.

In accordance with a second aspect of the invention, there is provided a flow control valve unit for an irrigation system, said flow control valve unit having at least one electrically operable valve operable between an off condition in which water under pressure would be prevented from flowing and an on condition in which water under pressure would be able to flow, operation of each said electrically operable valve being controlled by a processor interfaced with each said electrically operable valve by a switching circuit, said processor receiving address data being a user allocated identification number corresponding to a watering zone/station number allocated by the user to each said electrically operable valve, to set the watering zone/station number for each said electrically operable valve, and receiving by download and storing relative time data relating to the time of day, and receiving by download and storing operation timing data relating to said user allocated identification number allocated to each said electrically operable valve, where said flow control valve unit continually updates stored relative time data based on internal clock data in order to track the time of day, and where said processor operates each said electrically operable valve in accordance with, the stored operation timing data relating to each said user allocated identification number as allocated by the user to each said electrically operable valve.

Preferably said processor receives and stores said address data.

Preferably, the operation timing data is pre-programmed in an external control unit, and uploaded from the external control unit to said flow control valve unit.

With this arrangement, an irrigation system may be built using a number of such, flow control valve units having an electrically operable valve, each of which can be allocated a unique identification number, and the electrically operable valve will operate at the time intended for the particular identification number allocated to the electrically operable valve. In addition, the operation timing data, which comprises art irrigation system watering program, may be pre-compiled by a user in the external control unit, before being sent to the flow control valve units that make up the irrigation system.

By way of explanation the identification number is a station number or zone number which may be an integer from 1 to 8, for example. When an irrigation system using a number of flow control valve units is set up, the flow control valve units will be operated in order, by ascending identification number, where programmed to run in accordance with the operation timing data.

While it is envisaged that the flow control unit will typically have a single electrically operable valve, it is possible in a preferred embodiment, for the flow control valve unit to have two or more said electrically operable valves, with said processor receiving separate said address data associated with each said electrically operable valve.

The external control unit can take the appearance of a traditional irrigation controller, or as will be understood can be provided as an App for an iPhone or other Android device, or the like.

Preferably said processor receives and stores operation timing data relating to a plurality of different said identification numbers allocated to a plurality of said electrically operable valves, where said processor operates said electrically operable valve in accordance with the stored operation timing data relating to said identification number allocated to said electrically operable valve.

In this manner the processor stores the entire programming data for an irrigation system formed with a number of such flow control valve units, but the flow control valve unit operates only at the time intended for the identification number allocated to the electrically operable valve.

It will be appreciated that if two outputs or electrically operable valves have the same identification number, they will operate at the same time, in accordance with the stored operation timing data relating to the identification number allocated to the electrically operable valves.

Preferably said processor receives and stores operation timing data relating to one or more of a plurality of start times and run times or stop times, and days on which said start times may be allowed or over-ridden.

Preferably said processor is configured to add one minute to the run time(s) or stop time(s) stored, so that watering will overlap at the change over between successive valves, in order to prevent a situation where there is no valve open due to time data differences between individual flow control valve units. A situation when a valve is closed when it should be open can cause problems where a pump operates against a closed head.

Alternatively said processor is configured to add one minute between the run time(s) or stop time(s) stored, so that watering will not overlap at the change over between successive valves, in order to prevent a situation where there is reduced flow which could cause watering problems due to insufficient pressure. This also deals with time data differences between individual flow control valve units.

Preferably said processor receives or updates said operation timing data as a compiled serial data stream.

Also preferably, said processor also receives or updates relative time data as a part of said compiled serial data stream.

Preferably said identification number is received from a user operable selector switch.

Preferably, in a flow control valve unit having more than one electrically operable valve, there is a user operable selector switch associated with each electrically operable valve.

Preferably said user operable selector switch selects a number from 1 upward, corresponding to the watering zone/station number.

Preferably said user operable selector switch includes an off/manual override position, in which said flow control valve unit is suspended from operating in accordance with the stored operation timing data, and may be operated manually. Manual operation may commence by the user selecting a manual override position, or by a separate user operable switch.

In one preferred form, the flow control valve unit incorporates a transceiver, through which said serial data stream, is received. The transceiver need only be short range, and infrared may prove suitable, however, most preferably the transceiver is a radio transceiver. This may use Bluetooth, WiFi, or any other suitable standard.

Preferably said transceiver is arranged to be activated on operation of a user operable control located on the flow control valve unit for a predetermined period of time, whereafter in the absence of continuing data transmission or reception, said transceiver is deactivated. In the case of a battery powered flow control valve unit, this allows the flow control valve unit to conserve power and maximise battery life. The user operable control may be the separate user operable switch identified above, or another user operable switch. If it is the separate user operable switch identified above, the flow control valve unit may be configured to not actuate the transceiver nor be reprogrammed in accordance with the data contained in the serial data stream, unless the user operable selector switch has selected a number from 1 upward, corresponding to the watering zone/station number.

With Bluetooth implementation, the flow control valve unit will be capable of being paired with a controller. This allows the flow control valve unit to be incorporated into an irrigation system comprising a number of separate flow control valve units, all running in accordance with the operation timing data received from the controller.

The difference between the invention according to the first and second aspects is that the first aspect of the invention is a controller having at least one output to connect to an electrically operable valve, and an identification number can be allocated to each output, which determines the identity of the output, which in turn determines when in a sequence, the output is run; whereas the second aspect incorporates the controller with each electrically operable valve. There may be a single output or electrically operable valve, or multiple outputs or electrically operable valves. Units having one, two, or four electrically operable valves are envisaged for the invention according to the second aspect, whereas controllers having 8, 12 or 16 outputs and associated identification numbers are envisaged for the invention according to the first aspect.

In accordance with a third aspect of the invention there is provided an irrigation system comprising a user settable external control unit including a processor for storing watering data for one of more electrically operable valves contained within flow control valve units of the type described above and/or contained within one or more flow control valve controllers of the type described above, said watering data including start time and run time or stop time for each of said electrically operable valve, a real time clock for tracking at least the time and preferably the day of the week, a user interface for entering said watering data, and an output interface to transmit said watering data to a said flow control valve unit or a said flow control valve controller.

Preferably the user settable controller is hand-held and portable. In this manner, a user may take the controller out in the field and co-locate it with the flow control valve in order to transfer or update the watering data in the flow control valve.

### BRIEF DESCRIPTION OF DRAWINGS

A few preferred embodiments of the invention will now be described with reference to the drawings, in which:

FIG. 1 is a block schematic of a watering valve and control circuitry in the form of a tap timer, according to a first embodiment;

FIG. 2 is a block schematic of a watering valve and control circuitry in the form of a tap timer, according to a second embodiment;

FIG. 3 is a block schematic of a watering valve and control circuitry in the form of a tap timer, according to a third embodiment;

FIG. 4 is a memory map showing stored data contained in memory in a tap timer according any of the embodiments; and

FIGS. 5 to 12 are a view of the controller screen implemented in an iPhone App forming a user settable controller for programming any of the embodiments.

### DESCRIPTION OF EMBODIMENTS

All of three embodiments are a flow control valve unit in the form of a tap timer, for an irrigation system. While the embodiments implement the invention in the form of tap timers, the invention could be implemented in the form of plumbed in valves.

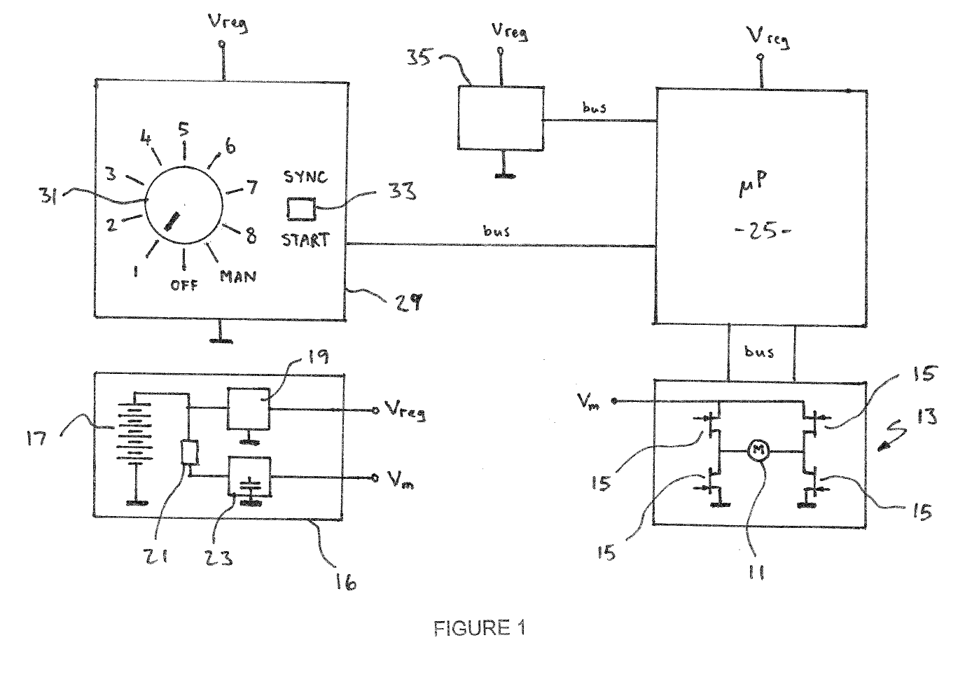

Referring to FIG. 1, the tap timer has an electrically operable valve (not shown), which is operable by a motor 11, between an off condition in which water under pressure would be prevented from flowing and an on condition in which water under pressure would be able to flow. The motor 11 is fed power by a switching circuit in the form of an H-Bridge circuit 13 comprising four FETs 15, in one polarity to run the motor in one direction in order to open the valve and run the motor 11 in the opposite direction in order to close the valve.

The tap timer has a power supply 16 with a 9 volt alkaline block battery 17, a voltage regulator 19 to provide power V_{reg} to the control electronics of the tap timer, and a charging circuit 21 and controlled capacitive discharge circuit 23 to provide power Vₘ to the H-Bridge circuit 13 when the motor 11 is to be operated. The circuitry 21 and 23 for controlling operation of the motor 11 is as described in the applicant's international patent application PCT/AU2015/050152, the contents of which are incorporated herein by cross reference.

Operation of the electrically operable valve is controlled by a processor 25 providing signals via system bus 27 interfaced with the H-Bridge circuit 13.

The processor 25 is connected with a control panel 29 having a user operable rotary switch 31 which is marked with indicia OFF to be selected by the user when the tap timer is to be inoperative or turned off, 1, 2, 3, 4, 5, 6, 7, and 8 being the identification number (i.e. the zone or station number) that the user intends to allocate to identify the zone to be watered by the tap timer, and MAN being the position a user would set the switch to if wanting to manually operate the tap timer. The user operable rotary switch 31 is shown in position 1, which means that the processor 25 will recognise the tap timer as being station 1.

The control panel 29 has an additional push to make user operable switch 33 which is used to commence watering when the rotary switch 31 is switched to the MAN position. The user operable switch 33 is also used to program the tap timer when the user operable switch 33 is not in the MAN position, and so serves a dual purpose.

The processor receives and stores for the purpose of comparison, address data being an identification number allocated to the tap timer, from the switch 31 to identify what zone the tap timer is, as is described above. In an alternative embodiment the address data may be a software implemented setting, which is downloaded by an external control unit, as will be discussed further hereunder.

The tap timer has a Bluetooth™ transceiver 35 (which has its own ID number in the form of an IP address) for communicating data including the actual time and day, and watering data/operation timing data. This is communicated to the processor 25 and stored, with the actual time and day being continually updated in real time from data supplied by an on-board dock. The updating of both the actual time and day, and watering data/watering operation timing data takes place when communicated via Bluetooth. On pressing the user operable switch 33, when the rotary switch 31 is selecting the desired watering zone number, the Bluetooth transceiver 35 is caused by the processor 25 to wake up, whereafter the data is received from an external control unit in the form of an iPhone running an App which contains the compiled station number, start time and run time for each day of the week. For expedience the entire program for all watering zones is downloaded to the processor and stored in internal memory, so the tap timer will run at the times for the zone number selected by the rotary switch 31.

The processor 25 will cause the H-Bridge circuit 13 comprising four MOSFETs 15, to run the motor 11 in one direction in order to open the valve at the programmed start time for the zone selected by the rotary switch 31, and run the motor 11 in the opposite direction in order to close the valve at the end of the run time for the zone selected by the rotary switch 31.

With this arrangement, an irrigation system may be built using a number of such tap timers, each having the zone selected by the rotary switch 31 to a different zone number, and the tap timers will operate at the time intended for the particular zone number. The operational irrigation system watering program is pre-compiled by the user in the controller, before being uploaded individually to each tap timer.

Where two tap timers have the same zone selected by the rotary switch 31, they will operate at the same time, in accordance with the stored operation timing data relating to the zone number. This is a useful feature in circumstances where there is sufficient water pressure, which is likely where several tap timers are running drip irrigation or watering potted plants.

The processor 25 or the App/controller can be configured to add one minute to the run times) or stop time(s) stored, so that watering will overlap at the change over between successive valves, in order to prevent a situation where there is no valve open due to time data differences between individual flow control valve units. A situation when a valve is closed when it should be open can cause problems where a pump operates against a closed head. However, this is not necessary when the tap timers are attached to a scheme water outlet, and in any event oscillator drift over time and with temperature variations, invariably causes time to drift between different units resulting in mismatch between stop and start times of successive tap timers.

The processor 25 is a Nordic Bluetooth Low Energy ARM M0 processor. This device is an nRF51322 which includes an on board 2.4 Ghz Bluetooth compliant transceiver and the ability to run a soft stack to provide Blue Tooth Low energy compliant communication.

The basic hardware of the Tap timer is relatively simple, there are three major parts to its design.

The first part of the design is the H-bridge circuit 13 and charging circuit 21 to provide an operation charge and control mechanism through the capacitive discharge circuit 23 to drive the bi directionally controlled motor 11 that is used to open and close the watering valve.

The second part of the design is the 2.4 Ghz Transceiver 35 used for Bluetooth communication. This design is as per the design notes supplied by Nordic and follows their PCB and schematic layout and consequentially their compliance path.

The third and final part of the design is that of the battery monitor. This made up of two A/D inputs of the processor 25 that are used to read the battery voltage and the charge voltage across the capacitive discharge circuit 25 used to supply energy to the H-bridge circuit 13.

The operation of the tap timer consists of the motor 11 which is part of a motor driven valve that is used to control the flow of water, and the associated electronics assembly that drives the MOSFET H-bridge circuit 13 that is used to control the motor direction and velocity of travel. Driving the motor in one direction until it finds its end stop opens the valve, and driving the motor in the opposite direction until the opposite end stop is struck closes the valve.

The H-bridge circuit 13 used to control the motor is controlled by two I/O pins that when active cause the open and close function to occur. In rest both I/O pins are low, when an action is required only one of the two I/O at a time is activated. As a matter of design, at no time should both I/O be driven high as this situation would result in a shorted power rail Vₘ that would cause failure.

The H-bridge circuit 13 is supplied with current via a dump capacitor in capacitive discharge circuit 23 that stores a charge with enough energy to make sure that the valve can open and then close again. The voltage across this capacitor is monitored by the Charge A/D input of processor 25. The processor 25 monitors the supply rail of the 9 volt battery and charge capacitor and decides when there is enough charge in the capacitor to allow the valve to be open. The valve will always be allowed to close, but it will not be allowed to open if a sufficient enough charge cannot be built up in, the capacitor, or if the battery supplying current to the timer has gone below the threshold considered safe for operation (6.3 volts)

The user interface system for the tap timer is based around the ten position rotary switch 31, a single press button enter key 33 and a bi coloured LED (Red/Green) which is used to signal status during Bluetooth binding between the tap timer and the controller.

The process of binding is only completed on the first use of the tap timer or after a reset and occurs between the controller (a Bluetooth phone or tablet) and the individual tap timer. The binding process passes the ID number of the Tap timer from the Tap timer to the controller. Once the timer has been identified and its ID number and user set channel number as selected by the rotary switch 31 stored, then it will be held in the controller for future linking purposes.

Binding of a single tap timer is achieved by turning the rotary switch 31 to the channel number/station number that will be used for the tap timer to be bound, and then pressing the user operable switch 33. At this point the Bi coloured led will flash green at a rate of 1 flash every 4 seconds and the Bluetooth transceiver in the tap timer will be turned on and will look for a controller to bind to. Also at this point an internal timer in the tap timer is started and a window of 5 minutes is created. During this window period the transceiver in the tap timer is kept alive so that the binding process can occur if possible.

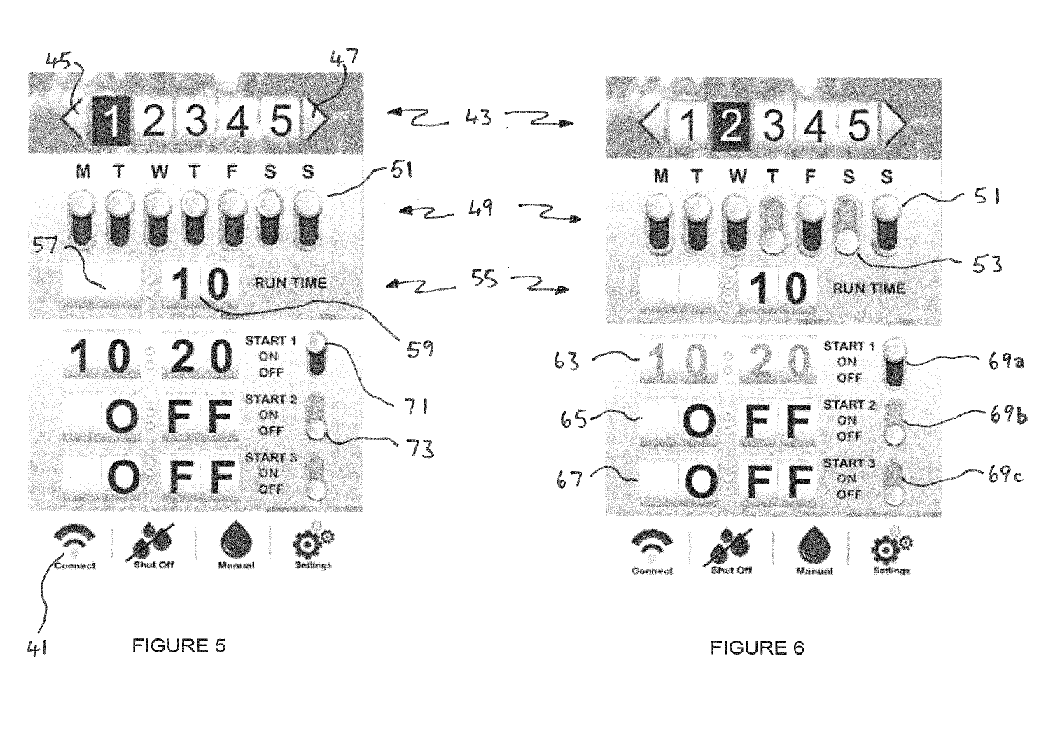

The controller is now able to be connected to the tap timer. The “Connect” button 41 on the controller (see FIG. 5) is pressed and the binding process occurs. The station/zone number on the rotary switch 31 tap timer is sent to the controller and the tap timer ID number is then associated with that station number.

More than one ID number can be associated with a station/watering zone. So it is possible to have multiple stations of the same station number across several individual tap timers.

Once the binding process has been completed then for all future connects to this individual tap timer the controller will use the station number and the information regarding that station will appear on the controller when a connection is made or when the tap timer re-establishes a connection.

Once a valid bind has occurred between a controller and a tap timer, the next step is to upload any valid data to the tap timer. Each tap timer is uploaded will all the information for all stations from the controller. Every tap timer holds all the information for all eight possible stations and this information is available at any point to any bound tap timer.

The upload also includes the current time and seconds information from the controller. This information is used to correct for any time discrepancies that might occur between individual tap timers and the controller. There will always be drift but if the clock is corrected whenever the controller is connected then it is possible to periodically re-sync all the tap timers bound in the system.

Once the tap timer has been uploaded with watering program data, it turns off the green 4 second flash LED and flashes the red LED 4 times with an interval of 0.5 seconds to signify that it has been uploaded, and the Tap Timer turns off the transceiver and disconnects from the controller. It now runs as an autonomous tap timer according to the programmed timing for the watering zone, and doesn't require any further intervention from the controller.

Some discussion regarding security is warranted. A security issue arises where a third party may attempt without authority to bind a different controller or an App stored in a portable device such as an iPhone or Android phone, and so without authority over-ride the intended stored timer settings. In this preferred embodiment, when the initial binding takes place, the tap timer processor stores the UUID of the Bluetooth device, and thereafter the processor is configured to respond only to that Bluetooth device with that UUIP until such time as it is manually reset by the user. Typically, BLE low energy Bluetooth is used in the tap timer circuitry, which periodically goes into beacon mode, during which it would be discoverable by and connectable with any Bluetooth device, in the absence of UUID authentication by the processor. An alternative is envisaged using BLE Mesh Bluetooth which is anticipated to be released in the not too distant future, where the BLE Mesh Bluetooth device in the tap timer will respond only to the Bluetooth device of the controller that originally set it up, until such time as a manual reset is performed by the user.

A further alternative is envisaged where a manual lock function in the form of a user settable switch is provided in the tap timer. This could be a dedicated switch which causes the controller to over-ride the beacon mode of the BLE Bluetooth device in the tap timer, and prevent the tap timer being discoverable.

Alternatively for the embodiment shown in FIG. 1, the existing switches on the front panel of the tap timer could be used in combination, to fulfil the same function. An example is described below.

Once the binding and programming has successfully taken place, with the switch 31 in the selected ID number, if the switch 33 is pressed, the tap timer will look for a controller to bind to, as described above. If during this period, the switch 31 is selected to the “OFF” or “MAN” position (or combined “OFF/MAN” position in an alternative embodiment), the tap timer goes into a locked condition, with the Bluetooth beacon mode is turned off, preventing the tap timer from being discoverable until the switch 31 is returned to an ID number. The processor of the tap timer stores the last selected ID number, while in this locked position, so that the intended operation of the tap timer can continue, regardless of the switch position being “OFF” or “MAN”. If this arrangement is adopted, the indicia on the panel of the tap timer would need to be amended from that shown in FIG. 1. To run in manual mode as described below, the switch 31 would need to be taken out of the locked position first, before the procedure is followed as described below.

The rotary switch 31 on the Tap timer now acts as a station selection device, so should one wish to use a different station run and start time to the current selected, one then changes the dial to the new desired station and it will now operate as per the selected station/watering, zone. In normal operation the dial would be left on the station that it was bound with to the controller.

The tap timer once bound and programmed with data becomes an autonomous device. It will operate automatically and will display the information for the station number that the rotary switch 31 is pointing to.

However if a manual operation is required then it is possible to do this for any of the eight stations. The process is as follows.

Turn the rotary switch 31 to the “MAN” position, and then press the enter key. The red LED turns on and a window timer of eight seconds is started. During this window the red LED stays illuminated and also the manual station select function is enabled. If the rotary switch 31 is left in this position then the eight second window will time out and the red LED will extinguish and nothing more will happen. However if the rotary switch 31 is turned to a station number and that station number has a valid run time programmed in to it from the master Bluetooth device then, once the eight second window expires the RED led will turn off and the tap timer will open and start running the selected station run time.

It should be noted that in an alternative embodiment, the MAN position in rotary switch 31 can be fulfilled by the OFF position, to implement manual operation of the tap timer. In this arrangement, a nine position switch is utilised for the rotary switch 31. To commence manual watering, turn the rotary switch 31 to the “OFF” position, and then press the enter key. The red LED turns on and a window timer of eight seconds is started. During this window the red LED stays illuminated and also the manual station select function is enabled. If the rotary switch 31 is left in this position then the eight second window will time out and the red LED will extinguish and nothing more will happen. However if the rotary switch 31 is turned to a station number and that station number has a valid run time programmed in to it from the master Bluetooth device then, once the eight second window expires the RED led will turn off and the Tap timer will open and start running the selected station run time.

Whilst a tap timer is open, i.e. running a station run time either in automatic or manual mode, then the green led will flash once every 10 seconds, to indicate that the valve in the timer is open and watering is taking place. Once run time expires then the timer reverts back to automatic operation. The station that will run automatically will be the station number that was programmed when the tap timer was bound to the controller, regardless of the position of the dial. The only exception to this would be if the rotary switch 31 was left in the “OFF” position in which case all automatic operation of the tap timer will be halted.

To stop all automatic watering of the single tap timer, the rotary switch 31 is turned to the “OFF” position and left in this position. In doing this the timer goes into a very low power mode. No watering will take place until the dial is turned back to any position other than “OFF”

As soon as the rotary switch 31 is changed back to one of the station numbers then automatic watering is reactivated in accordance with the selected station number watering regime as programmed by the controller.

Should the low battery warning become active whilst the timer is set to “OFF”, the red LED is flashed once every 20 seconds.

Should the rotary switch 31 be turned to the “OFF” position whilst a run is in progress, then that run time is halted, the 10 second flash of the green LED is stopped and the valve is closed.

Once the timer has stopped watering then the rotary switch 31 can be returned to the station position it was on or if left in the OFF position then the halt all watering function takes control and no further automatic watering will take place.

When the tap timer that has been bound to a controller and has a valid run time and at least one valid start time/day schedule, it will water automatically, starting and running on the programmed starting times when they become valid.

Whilst in automatic mode, the tap timer will flash the green LED once every 20 seconds. It will only do this if there is valid data, otherwise there will be no visual indication.

Once every minute the tap timer compares the RTC with the start time or time programmed, and if it finds a matching time then it checks for a valid day schedule. If there is also a valid day schedule then the A/D is powered up and the battery is tested. If there is enough charge in the battery and capacitor then the tap timer is opened and the tap timer starts running the associated run time for the station that it is bound to. It will stay open for the duration of the run time for the station. As soon as the run time expires the valve is shut down and the timer reverts back to looking every minute for valid start times.

Whilst the timer is running, if it finds another start time that would cause conflict if started, then this start is noted and added to a run stack. One the current run time is finished then the run stack is decremented and if there is another start set, this start time causes the timer to start again and run the associated run time for the station. The depth of the stack is 4 levels so if all 4 starts overlap then they will all be able to run at some point.

The Battery A/D is only used when the valve is turning on. At turn off the A/D cannot inhibit the unit from turning off from low battery, the assumption is that no matter what, the valve must close, and if there has been enough energy to open the valve then there will be enough energy to turn it off.

The battery voltage is checked by the A/D once every minute. There are two values that are used for comparison, the first is the operational value and the second value is the shutdown value.

If the value returned by the A/D is above the shutdown value then the timer keeps on working. If the A/D returns a value below the shutdown value then the timer is shutdown and the red led is flashed once every 20 seconds.

If at some point the battery recovers and the value returned by the A/D is above the Operational value, which is unlikely at this point, then the timer reverts to normal operation and the 20 second flash of the red led is halted. This means should a flat battery be replaced whilst in this state and there is enough energy in the circuit to maintain the RTC and the on board RAM. Then the replacement battery would bring the A/D reading above the acceptable operational value and there would be no need to go, through the process of re-binding.

The battery monitor also looks at the battery before it will allow an automatic start to commence or a manual start to be activated. If the value returned from the A/D reading tested before a valve opening is below the Operational value then the valve is not allowed to open.

If this occurs the red LED is flashed, once every 20 seconds to indicate a flat battery. If at some point the battery recovers and the value returned by the A/D is above the Operational value then the timer reverts to normal operation and the 20 second flash of the red LED is halted.

The capacitor charge A/D works in a similar fashion to the Battery monitor, with the exception it is used to monitor the actual voltage attained on the Charge capacitor in the capacitive discharge circuit 23.

Once a minute after the battery has been tested, the charge, capacitor in the capacitive discharge circuit 23 is also tested and should the measured voltage be 1 volt or more less than the battery voltage, then the charging circuit 21 is enabled and the capacitor is topped up. Once the charge capacitor has been topped up the charging circuit 21 is turned off to save power.

When the valve is being operated either opening or closing, the charge circuit 21 is disabled so that the battery is isolated from the “H” bridge circuit 13. This is achieved by disconnecting the charge circuit 21, so that when the H-bridge circuit 13 becomes active the battery does not see a large load and droop so far that a processor reset might occur.

If there is not enough charge in the charge capacitor in the capacitive discharge circuit 23, the valve is inhibited from turning on.

Once the valve has been turned on the “H” bridge circuit 13 control I/O are both in the rest state then the charge circuit is enabled and the capacitor in the capacitive discharge circuit 23 is refilled.

No open functions nor close functions are allowed until the voltage on the charge capacitor is within, or has recovered to be within 1 volt of the battery supply rail, this ensures there will always be maximum charge on the capacitor for the H-bridge circuit to use.

The user operable switch 33 functions as an “Enter” key, which when pressed creates an interrupt and a jump to the function which is either the bind process if the dial is on a station number or the manual operation function, should the switch be set in the “MAN” position (or “OFF” position as discussed in connection with the alternative embodiment.

The RTC is set to create a 20 second interrupt/tic count during normal timing and running mode. This is designed to minimize the current consumption during normal operation but at the same time maintain the ability to flash the green and red LED's with a period of 20 seconds. Once the enter key is pressed or an A/D conversion is required then RTC changes to a 0.5 second tic count and remains this way for a period of 5 minutes after the last activity or key change has occurred or until the A/D has returned a value and the function associated with the A/D has been completed. In this mode the power consumed is considered to be quite high but it allows for fast interaction with any operation that might occur from operator intervention.

Where ever possible the lowest power consumption for a specific function is used and thus power consumption is minimized.

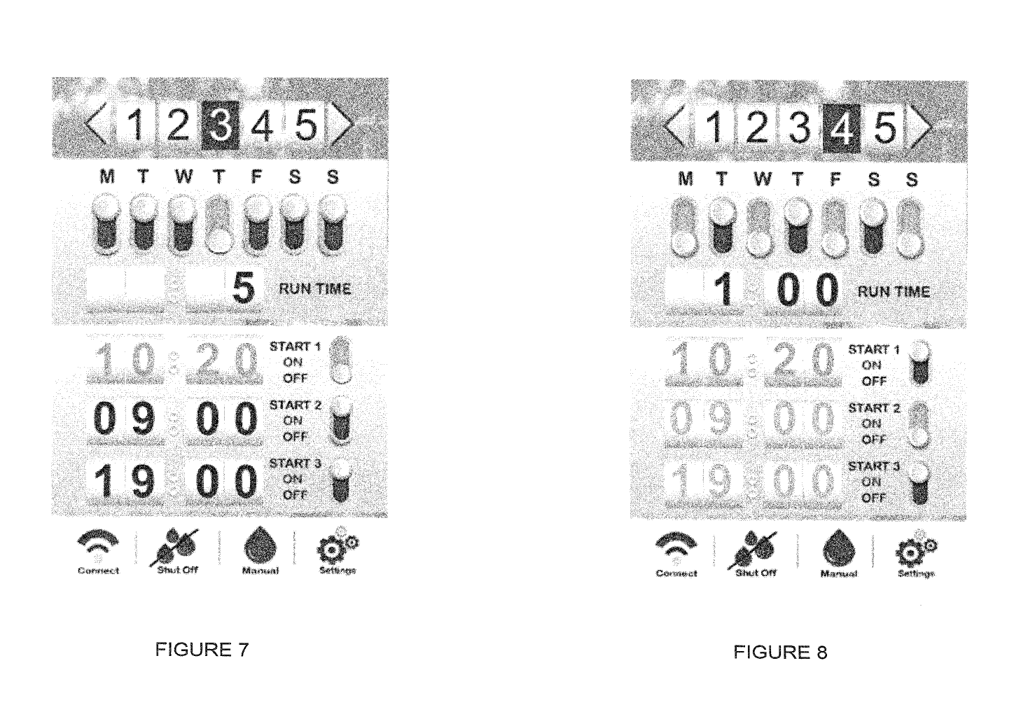

FIG. 5 shows the screen artwork for an iPhone or iPad App where these devices fulfil the function of an external control unit. The Bluetooth connect key 41 has already been discussed above. A slide bar 43 is provided at the top of the screen. This has left arrow 45 and right arrow 47 which are used to navigate between station/zone numbers 1 to 8 (in this embodiment) which correspond with the identification number settable by the user operable rotary switch 31 which is associated with an electrically operable valve contained within the tap timer. The right arrow 47 will navigate the displayed station numbers from 1 to 5 to 4 to 8, and the left arrow 45 will navigate the displayed station numbers back again to 1 to 5. A desired station number can be selected by touching it, and then operation timing data associated with that station number can be entered into and stored in the App. In FIG. 5, station number 1 is selected, in FIG. 6 station number 2 is selected, in FIG. 7 station number 3 is selected, and in FIG. 8 station number 4 is selected.

Below the slide bar 43 is a series of seven switches 49, one for each day of the week, which may be slid between on 51 and off 53 to select whether the station number selected in the slide bar 43 will run on the day concerned, and a run time bar 55 showing hours 57 and minutes 59.

Below this is a programme start time window 61 providing three possible start times 63, 65, and 67 to be programmed for each station number selected in the slide bar 43. The start time displayed in 24 hour format is the start time for which the lowest active station number programmed for the particular day, will commence watering. A switch 69a, 69b and 69c is associated with each start time (Start 1, Start 2, and Start 3 respectively), selectable on 71, or off 73.

Also included are a shut off button 75, which can be used to turn off a selected tap timer once coupled via Bluetooth. A manual button 77 can be used to start a selected tap timer watering for its station time, once coupled via Bluetooth.

In FIG. 5, station 1 has been selected to turn on every day, and have a run time of 10 minutes. Start 1 has been activated for station 1 and it has been set to 10:20 am. No other start is set for station 1, so the other two starts remain “OFF”. The setting of start 1 was performed when valve 1 was in the foreground, so the start time is shown bold.

Referring to FIG. 6, using the slide bar 43 at the top of the screen station 2 is selected, and switches 49 set station 2 watering days to water on Monday, Tuesday Wednesday, Friday and Saturday. In this particular instance, the run time for station 2 is also 10 minutes. As it is desired that station 2 uses start 1, the start 1 switch 69 a is set to on 71 The start time for start 1 cannot be changed as this has already been set for station 1 so in this case the Start time is displayed but greyed out.

In this situation at 10:20, station 1 will turn on, run for 10 minutes then turn off, every day of the week. One minute later station 2 will turn on and run for 10 minutes as well, except on Thursday and Saturday station 2 will not turn on as the day schedule doesn't match.

Referring to FIG. 7, using the slide bar 43 at the top of the screen station 3 is selected, and switches 49 set station 3 watering days to water on every day except Thursday. Station 3 needs to start twice per day and the first start is required to before the time set for Start 1. Accordingly, Start 2 is set to start at 9:00 am and Start 3 is set for 19:00 ie 700 pm. The run time for both starts is 5 minutes. Start 1 is not turned on for this valve. As station 3 is the earliest station number in the sequence that either start 2 or start 3 have been used, they are bold and are able to be altered. Start 1 is greyed out because it has already been set, and the on/riff switch 69a for start 1 is in the off position, which means that station 3 will not water in the sequence that commences at 10:20.

Referring to FIG. 8, Using the top slide bar 43 station 4 is selected, and the watering days are set to Tuesday, Thursday and Saturday with a run time of one Hour. Start 1 and Start 3 have been turned on. Station 4 will start on start 1 at 10:42 am and will run for one hour on Tuesday. On Thursday and Saturday station 4 it will start at 10:31 am and run for one hour. For start 3, station 4 will turn on after station 3 has closed. So on Tuesday, Thursday and Saturday, station 4 will turn on 19:06 ie 7:06 pm and will run for one hour.

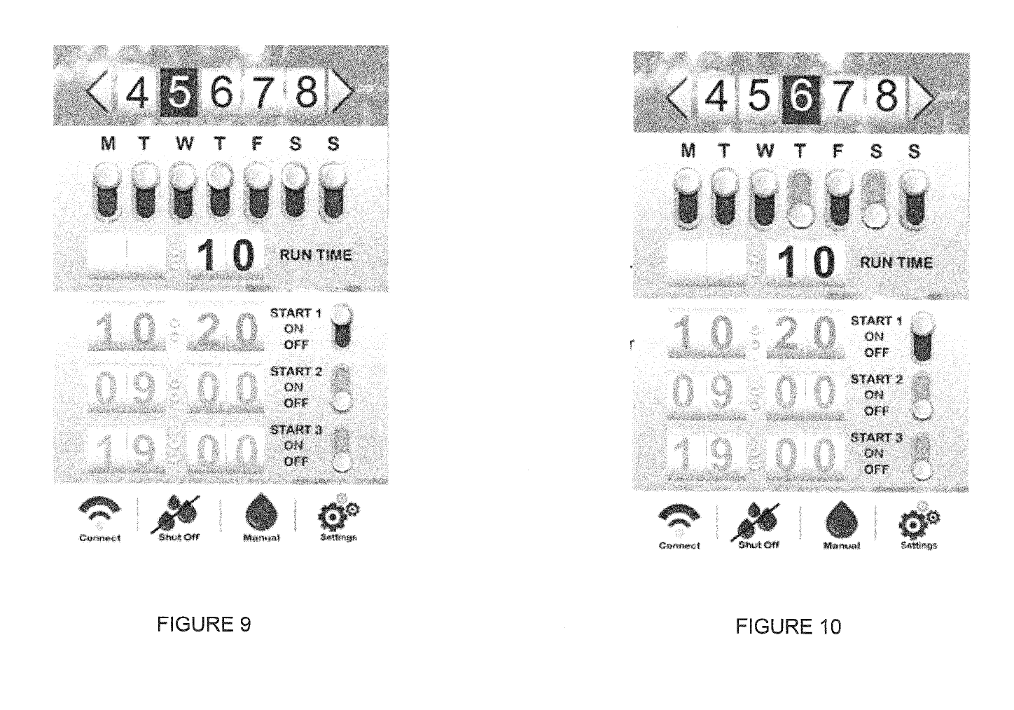

Referring to FIG. 9, station 5 has been set to turn on every day, and have a run time of 10 minutes. Start 1 has already been activated by station 1 and set to 10:20 am. No other start time is used by station 5. On Monday, Wednesday, Friday and Sunday station 5 will start at 10:42 am and will run for 10 minutes. On Thursday and Saturday, Station 5 will start at 11:32 am and will run for 10 minutes and on Tuesday, station 5 will start at 11:42 am and will run for 10 minutes.

Referring to FIG. 10, station 6 has been set to water on Monday, Tuesday Wednesday, Friday and Saturday, for a run time also of 10 minutes. Start 1 is the only active start selected, with all other starts for station 6 being turned off. Station 6 will start on Monday, Wednesday, Friday and Sunday at 10:53 am and will run for 10 minutes. On Tuesday station 6 will start at 11:53 am and will run for 10 minutes.

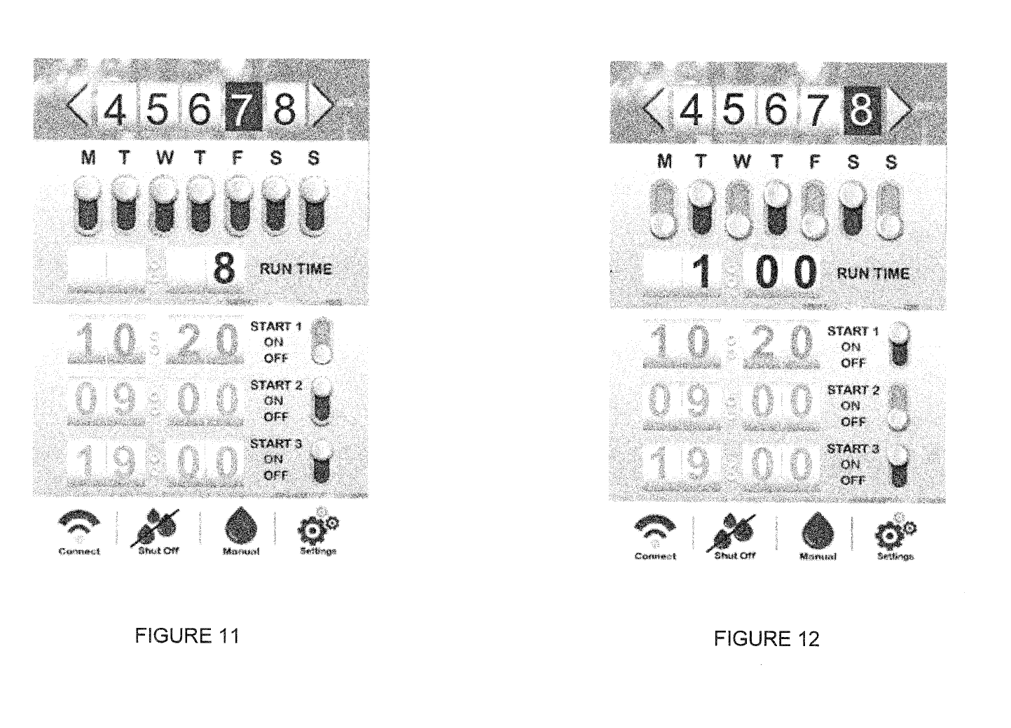

Referring to FIG. 11, station 7 has been set to water on every day for 8 minutes. It is required that station 7 runs twice a day and start 2 and start 3 are, turned on to achieve this. Start 1 is not turned on for station 7, Station 7 will start on every day at 9:07 am and will run for 8 minutes, except on Thursday station 7 will start at 9:00 am and run for 8 minutes. In the evening on Monday, Wednesday, Friday and Saturday station 7 will open at 19:06 and will run for 8 minutes. On Tuesday and Saturday, station 7 will start at 20:07 and run for 8 minutes. On Thursday station 7 will turn on at 20:01 and run for 8 minutes.

Finally, referring to FIG. 12, station 8 has been set to water on Tuesday, Thursday and Saturday with a run time of one hour. Start 1 and Start 3 have been turned on. On Tuesday station 8 will turn on at 13:03 for start 1 and 20:16 for start 3 and will run for one hour each time. On Thursday station 8 will turn on at 11:43 am for start 1 and 20:10 for start 3 and run for one hour each time. On Saturday station will turn on at 11:32 am for start 1 and 20:16 for start 3 and run for 1 hour each time.

Once the program has, been assembled by the user as described, the App stores the scheduling in a table, which is uploaded to memory contained within the processor in each tap timer, after each timer has been paired using the Bluetooth connection as described above.

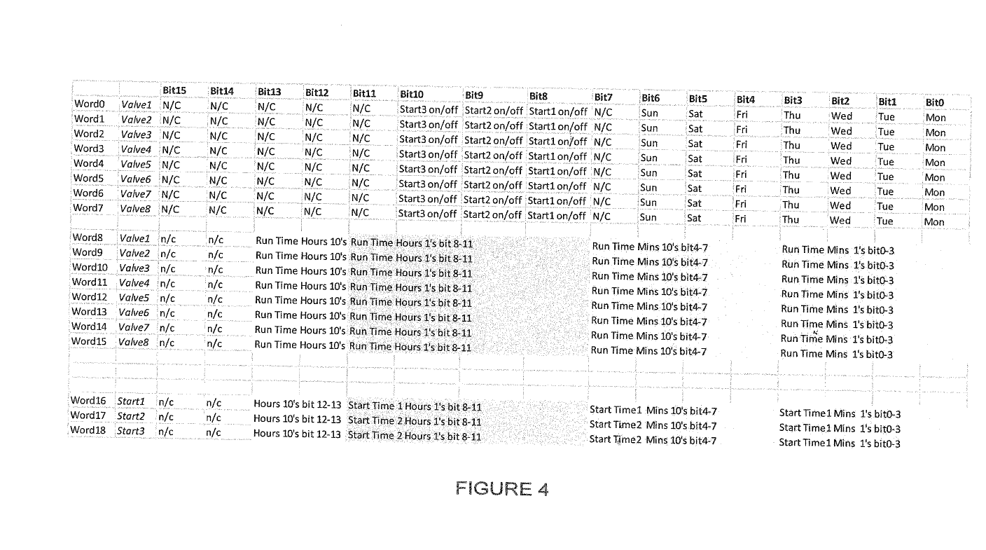

Referring to FIG. 4, the memory map for the processor 25 is shown. As discussed above, each tap timer contains all the information for all eight possible stations. With this feature, at run time each tap timer can decide if it should be on or not and doesn't need to rely on the App to sort out run times and offsets prior to run time. This greatly simplifies the App and removes the complexities of scheduling the run times.

The data contained in the table in FIG. 4 has to be transmitted to and stored in memory in the processor in each tap timer in an irrigation system built with tap timers according to the embodiments, after a modification has been made to the watering schedule, if the whole system is to stay in synchronisation and with no valve watering timing overlaps. It will be understood that only when there is a change in start times or an increase in run time, will a situation occur when an overlap can occur if all tap timers in the system are not updated.

To clarify the memory map, run times and start times are stored as BCD nibbles, start time 10's of hours and run time 10's of hours only require 2 bits. The days on and off for each valve are held in the low byte of word0 to word7. When set the day is on, and when zeroed the day concerned is off. The start on/off switches for each valve are stored in Bit8 through Bit10 of word0 to word7.

The bits 11 to 15 of Word0 to word7 are used as stack counters for each valve. Every time a start match occurs that requires the valve to open, the stack for the valve is incremented, and every time a start occurs the stack is decremented. The stack for each valve is looked at sequentially in the tap timer and the watering arbitration is based on this count from tap timer to tap timer. In essence every tap timer knows what every other tap timer is doing. The placement of the overlap 1 min timer is accomplished at the tap timer, which means there is no need to do this in the App.

To describe how the data is written into the memory map by the App, using the above graphic user interface shown in FIG. 5 GUI of Valve 1 as an example, the following data would be placed into the map. Using the slide bar 43 at the top of the screen the station 1 is selecte.

The days of the week that the timer can operate would then be placed into Word 0 from Bit0 to Bit6. A day that is active is set and a day that is inactive is cleared. The run time is broken into 4 nibbles of BCD data and in this case the data would be placed into Word8, with the 1's of mins in bit0-3, the 10s of mins in bit4-7, the of hours is in bit 8 to 11 and the 10's of hours are held in bit12 and bit13. Bit14 through to bit15 are not used. The three start times are held in word16, word17 and word18. The data is held as per the run times in 4 bit BCD nibbles.

In word 0 to word 7 there is a matrix of flags that represent the status in real time of each individual stations start times, i.e. if the start is active or not. Looking at the sample screen only start 1 is active for station 1 so in this case the Bit flag is set at Word0 bit 8. Each station in the GUI sets these flags on or off depending what has been set. With this information the tap timer software can determine if a start needs to be shifted or not.

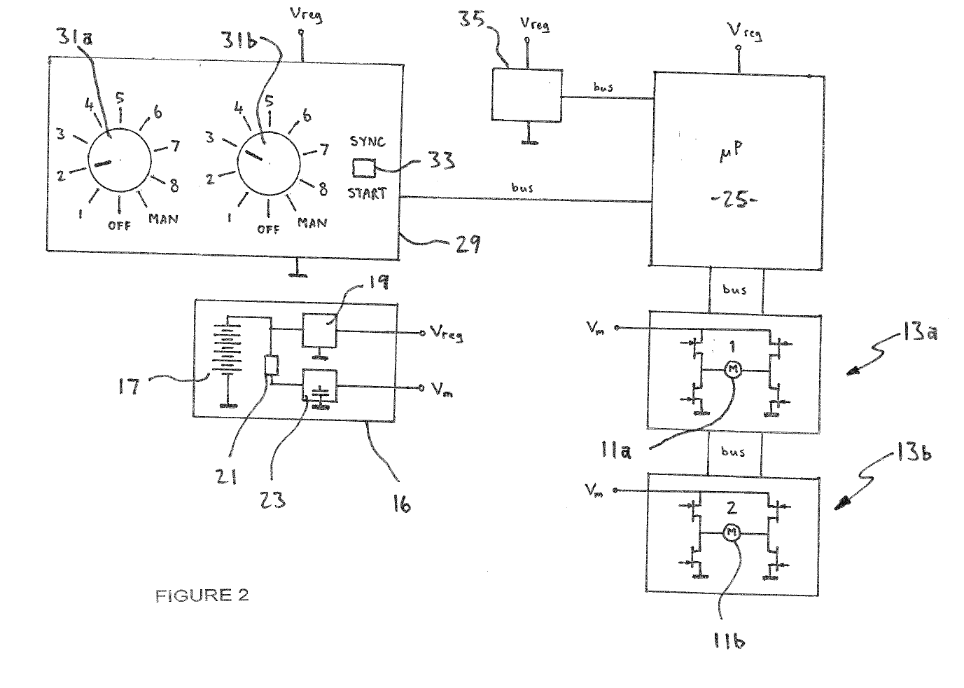

Referring to FIG. 2, a second embodiment of tap timer being a two station tap timer, is illustrated. This tap timer differs from that of the first embodiment in that there are two H-bridge circuits 13a and 13b controlling two separate motors 11a and 11b respectively which operate two separate electrically operable valves (not shown). The control panel 29 has two separate user operable rotary switches 31a and 31b, which are associated with respective H-bridge circuits 13a and 13b. In effect the second embodiment is a two outlet/valve tap timer within a single housing, with its operation controlled by processor 25. Rotary switch 31a is shown selecting the electrically operable valve connected to motor 11a to be designated as station 2. Rotary switch 31b is shown selecting the electrically operable valve connected to motor 11b to be designated as station 3.

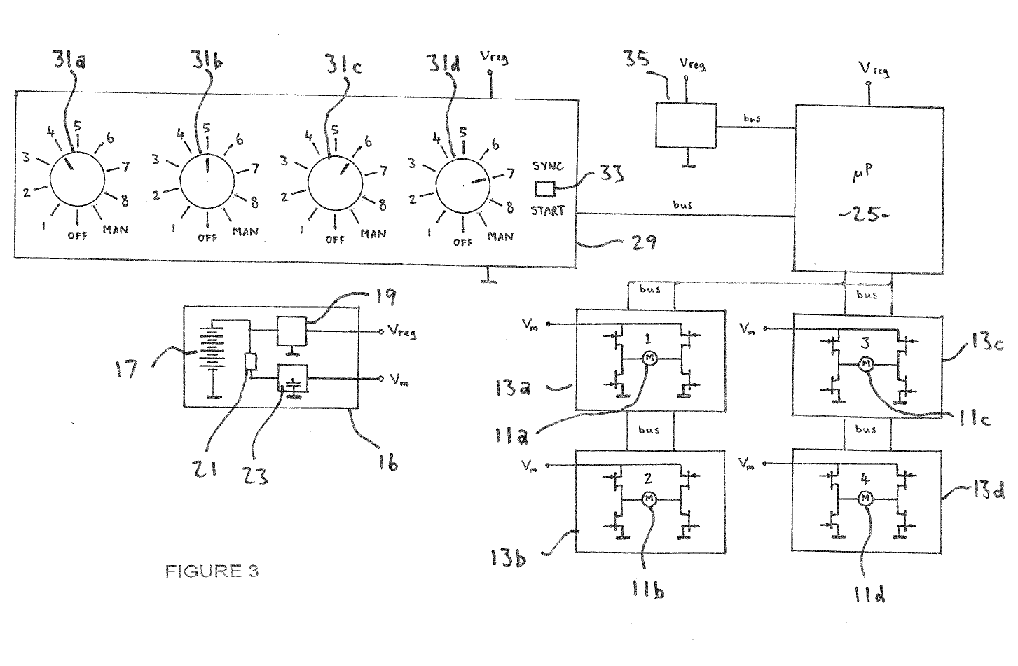

Referring to FIG. 3, a third embodiment of tap timer being, a four station tap timer, is illustrated. This tap timer differs from that of the first embodiment in that there are four H-bridge circuits 13a, 13b, 13c and 13d controlling two separate motors 11a, 11b, 11c and 11d respectively which operate four separate electrically operable valves (not shown). The control panel 29 has two separate user operable rotary switches 31a, 31b, 31c and 31d which are associated with respective H-bridge circuits 13a, 13b, 13c and 13d. In effect the third embodiment is a four outlet/valve tap timer within a single housing, with its operation controlled by processor 25. Rotary switch 31a is shown selecting the electrically operable valve connected to motor 11a to be designated as station 4. Rotary switch 31b is shown selecting the electrically operable valve connected to motor 11b to be designated as station 5. Rotary switch 31c is shown selecting the electrically operable valve connected to motor 11c to be designated as station 6. Rotary switch 31d is shown selecting the electrically operable valve connected to motor 11d to be designated as station 7.

If stations 1 to 7 were programmed in the App as described, and paired via Bluetooth to each of the embodiments shown in FIGS. 1, 2 and 3, the three tap timers would operate as a seven station irrigation system, with the tap timer of the first embodiment being station 1, the tap timer of the second embodiment being stations 2 and 3, and the tap timer of the third embodiment being stations 4, 5, 6 and 7.

It will be understood that the invention provides the ability for the user to configure their garden irrigation schedule in the comfort of their armchair, and then take the preconfigured schedule to their individual tap timers and upload the schedule to the tap timers. Afterwards the tap timers will function autonomously, but in unison, as a system.

In an alternative embodiment, it will be understood that the invention can provide the ability for the user to configure their garden irrigation schedule in the comfort of their armchair, and then take the preconfigured schedule to their irrigation controller box and upload the schedule to the irrigation controller. This would simplify irrigation controller design, as the irrigation controller will no longer need to have a user display, and will require minimal user operable controls, namely the station select rotary switch for each station and the enter key.

Having described the invention, a skilled addressee will appreciate that minor changes may be made without departing from the spirit and scope of the invention.

What is claimed is:

1. A flow control valve controller for an irrigation system, said flow control valve controller having at least one output to connect to an electrically operable valve operable between an off condition in which water under pressure would be prevented from flowing and an on condition in which water under pressure would be able to flow, operation of each said output being controlled by a processor interfaced with each said output by a switching circuit, said processor receiving address data being a user allocated identification number corresponding to a watering zone/station number allocated by the user to each said output, to set the watering zone/station number for each said output, and receiving by download and storing relative time data relating to the time of day, and receiving by download and storing operation timing data relating to said user allocated identification number allocated to said each said output, where said flow control valve controller continually updates stored relative time data based on internal clock data in order to track the time of day, and where said processor operates each said output in accordance with the stored operation timing data relating to said user allocated identification number as allocated by the user to each said output.

2. A flow control valve controller as claimed in claim 1 wherein said processor receives and stores said address data.

3. A flow control valve controller as claimed in claim 1 wherein the operation timing data is pre-programmed in an external control unit, and uploaded from the external control unit to said flow control valve controller.

4. A flow control valve controller as claimed in claim 1 wherein said processor receives and stores operation timing data relating to a plurality of different said identification numbers allocated to a plurality of said outputs, where said processor operates said output in accordance with the stored operation timing data relating to said identification number allocated to said output.

5. A flow control valve controller as claimed in claim 1 wherein said processor receives and stores operation timing data relating to one or more of a plurality of start times and run times or stop times, and days on which said start times may be allowed or over-ridden.

6. A flow control valve controller as claimed in claim 1 wherein said processor receives or updates said operation timing data as a compiled serial data stream.

7. A flow control valve controller as claimed in claim 6 wherein said processor also receives or updates relative time data as a part of said compiled serial data stream.

8. A flow control valve controller as claimed in claim 1 wherein each said user allocated identification number is received from a user operable selector switch.

9. A flow control valve controller as claimed in claim 8 wherein each said user operable selector switch selects a number from 1 upward, corresponding to the watering zone/station number.

10. A flow control valve controller as claimed in claim 9 wherein said user operable selector switch includes an off/manual override position, in which the associated said output is suspended from operating in accordance with the stored operation timing data, and may be operated manually.

11. A flow control valve controller as claimed in claim 1 wherein the flow control valve controller incorporates a transceiver, through which said serial data stream is received.

12. A flow control valve controller as claimed in claim 11 wherein said transceiver is arranged to be activated for a predetermined period of time, on operation of a user operable control located on the flow control valve controller, whereafter in the absence of continuing data transmission or reception, said transceiver is deactivated.

13. A flow control valve unit for an irrigation system, said flow control valve unit having a flow control valve controller as claimed in claim 1, with each said at least one output thereof operatively connected to a said electrically operable valve.

14. An irrigation system comprising a user settable external control unit including a processor for storing watering data for one of more electrically operable valves contained within flow control valve units as claimed in claim 13 and/or contained within one or more flow control valve controllers as claimed in claim 1, said watering data including start time and run time or stop time for each of said electrically operable valve, a real time clock for tracking at least the time and preferably the day of the week, a user interface for entering said watering data, and an output interface to transmit said watering data to a said flow control valve unit or a said flow control valve controller.

15. An irrigation system as claimed in claim 14 wherein the user settable controller is hand-held and portable.

16. A flow control valve controller for an irrigation system, said flow control valve controller having at least one output to connect to an electrically operable valve operable between an off condition in which water under pressure would be prevented from flowing and an on condition in which water under pressure would be able to flow, operation of each said output being controlled by a processor interfaced with each said output by a switching circuit, said processor receiving address data being a user allocated identification number corresponding to a watering zone/station number allocated by the user to each said output, to set the watering zone/station number for each said output, and receiving by download and storing relative time data relating to the time of day, and receiving by download and storing operation timing data relating to said user allocated identification number allocated to said each said output, where said flow control valve controller continually updates stored relative time data based on internal clock data in order to track the time of day, and where said processor operates each said output in accordance with the stored operation timing data relating to said user allocated identification number as allocated by the user to each said output, wherein the operation timing data is pre-programmed in an external control unit, and uploaded from the external control unit to said flow control valve controller, and wherein said processor receives and stores operation timing data relating to a plurality of different said identification numbers allocated to a plurality of said outputs, where said processor operates said output in accordance with the stored operation timing data relating to said identification number allocated to said output.

17. A flow control valve controller as claimed in claim 16 wherein said processor receives and stores operation timing data relating to one or more of a plurality of start times and run times or stop times, and days on which said start times may be allowed or over-ridden.

18. A flow control valve controller as claimed in claim 16 wherein said processor receives or updates said operation timing data as a compiled serial data stream, and wherein said processor also receives or updates relative time data as a part of said compiled serial data stream.

19. A flow control valve controller as claimed in claim 16 wherein each said user allocated identification number is received from a user operable selector switch, selecting a number from 1 upward, corresponding to the watering zone/station number.

20. A flow control valve controller as claimed in claim 19 wherein said user operable selector switch includes an off/manual override position, in which the associated said output is suspended from operating in accordance with the stored operation timing data, and may be operated manually.
